(19) United States
(12) Patent Application Publication
(10) Pub. No.: US 2023/0251478 A1
(43) Pub. Date: Aug. 10, 2023

(54) High-Resolution Microscope with a Housing Covering Optical Elements Mounted to a Carrier Support

(71) Applicant: Abberior Instruments GmbH, Goettingen (DE)

(72) Inventor: Lars Kastrup, Goettingen (DE)

(21) Appl. No.: 18/134,209

(22) Filed: Apr. 13, 2023

Related U.S. Application Data
(63) Continuation of application No. PCT/EP2021/078092, filed on Oct. 12, 2021.

(30) Foreign Application Priority Data
Oct. 14, 2020 (EP) 20 201 734.9

(51) Int. Cl. G02B 21/00; G02B 21/26

(52) U.S. Cl. CPC G02B 21/0032; G02B 21/0048; G02B 21/26

(57) ABSTRACT

A high-resolution microscope comprises a carrier support, a plurality of beam guiding and beam forming optical elements mounted to the carrier support in a defined spatial arrangement, and a housing covering the optical elements mounted to the carrier support. The housing comprises a housing panel. The housing panel has two parallel facesheets and a core layer. The core layer is bonded to the two facesheets and includes at least one of a plurality of gas filled cavities and a heavy layer such that the housing panel prevents airborne sound and air flows that occur in the environment of the microscope from exciting the optical elements to vibrations.

### CROSS REFERENCES TO RELATED APPLICATIONS

The present application is a continuation of international patent application PCT/EP2021/078092 entitled “High-resolution microscope with a housing, and use of a housing to cover optical elements mounted on a support”, filed on Oct. 12, 2021, and claiming priority to European patent application EP 20 201 734.9 entitled “Hochauflosendes Mikroskop mit einem Gehause and Verwendung eines Gehauses zum Abdecken von an einem Trager montierten optischen Elementen”, and filed on Oct. 14, 2020.

### FIELD OF THE INVENTION

The present invention relates to a high-resolution microscope comprising a carrier support, a plurality of beam guiding and beam shaping optical elements mounted to the carrier support in a defined spatial arrangement, and a housing covering the optical elements mounted to the carrier support, the housing having a housing panel.

In the present application, the term “high-resolution microscope”, particularly refers to microscopes achieving a spatial resolution in the range of the diffraction limit or even better in imaging a structure of interest of a sample. More particularly, the high-resolution microscope may be a laser scanning microscope, a confocal microscope, a STED micropore, any other RESOLFT microscope, a MINFLUX microscope or a localization microscope, like for an example a GSDIM microscope.

### BACKGROUND

The larger the spatial resolution to be achieved by a microscope in imaging a structure of interest of a sample, the more stable the sample has to be positioned with respect to the microscope, i.e. kept at rest. Any uncontrolled movements of the sample with respect to the microscope result in in-motion unsharpness that considerably reduces the spatial resolution of the microscope. This particularly applies to such movements of the sample with respect to the microscope which can not be temporarily resolved and then corrected in imaging the sample and which are particularly associated with the occurrence of vibrations.

Often, massive and highly stiff structures to which a sample holder holding a sample and further components of a microscope are mounted are utilized to keep the sample at rest with respect to the microscope by which a structure of interest of the sample is imaged. However, such massive and highly stiff structures are not only heavy such that they result in an extremely high transport weight of the respective microscope but they also need a lot of space, and, especially, they are expensive.

Even in a high-resolution microscope with a massive and highly stiff carrier support for the beam guiding and beam shaping optical elements and with a housing covering the optical elements mounted to the carrier beam, vibrations often occur which can not suitably be suppressed by an even more massive and stiff design of the carrier support.

German patent application publication DE 10 2006 039 896 A1 and U.S. Pat. No. 7,936,502 to Wilson, which belong to the same patent family, disclose a microscope device comprising a microscope objective and a plate-like body limited by a flat top face and a flat lower face essentially parallel thereto. The microscope objective is connected tot the plate-like body. A portion of a beam path of the microscope device extends, essentially parallel to the top face and the lower face, within a recess within the plate-like body. Another portion of the beam path of the microscope extends above and/or below the plate-like body. The plate-like body is designed as an optical bench body and constructed like a vibration-damping optical bench, often also called “breadboard”, in a deformation-resistant and vibration-damping manner. Besides known materials for optical benches, such as a sandwich construction made of metal comprising a honeycomb-like interior layer, the plate-like body may have a cast-based body, for example, made of mineral casting.

International application publication WO 2016/170370 A2 and U.S. Pat. No. 10,962,755 to Kapanidis et al., which belong to the same patent family, disclose a microscope comprising an enclosure, a carrier support, an optical support element supported at the carrier support within the enclosure, at least one vibration isolating mount between the carrier support and the optical support element and an optical system mounted to the optical support element. The housing completely encloses the optical path of the microscope.

German patent application publication DE 10 2009 008 706 A1 discloses the use of metal powder composite materials as construction materials for housings and housing parts of optical devices and optical modules like, for example, microscopes, macroscopes, cameras, telescopes, endoscopes and geodetical instruments, and their assemblies and modules. The composite material particularly includes a compact facesheet made of aluminum, and an inner area comprising pore structure and made of aluminum foam. The use of metal powder composite materials as construction materials shall reliably fulfill all criterions with respect to rigidity for housing constructions of modularly designed optical devices.

Patent application publication US 2002/0080229 A1 discloses a honeycomb structure integrally formed with a raster output scanning system housing. A so-called constrained layer damper is bonded to the honeycomb structure, and the raster outputs scanning system is mounted on the constrained layer damper. The honeycomb structure and the constrained layer damper provide support and reduce vibrations to the raster output scanning system.

A microscope with housing comprising a housing panel is known from 200 Microtime: “Super-resolution add-on for a confocal time-resolved microscopy platform”, Oct. 5, 2015 (2015 Oct. 5), XP055329436, see: URL: http://www.picoquant.com/images/uploads/down loads/m icrotime200_sted_webseite_05.10.15_web.pdf. The housing covers beam guiding and beam shaping optical elements mounted to a carrier support in a defined spatial arrangement.

Patent application publication US 2002/060842 A1 discloses a microscope having a housing that encloses the optical elements of the microscope and comprises housing panels. The housing panels are connected to a frame of the housing.

Panels comprising two parallel facesheets and a core layer fixed to the two facesheets and comprising gas filled cavities are generally known in different embodiments. These embodiments include panels with metal facesheets and core layers made of corrugated metal sheet, made of honeycombs running orthogonal to the facesheets, which may be formed of different materials including metal and plastic, or made of foamed plastics. Such panels are used in different technical fields like, for example, in railway vehicles, vessels, busses, building fronts, interior construction and general mechanical engineering.

There still is a need of a technical measure allowing for producing cheaper and preferably also lighter high-resolution microscopes in which the generation of relative movements between the sample and the microscope is prevented.

### SUMMARY OF THE INVENTION

The present invention relates to a high-resolution microscope comprising a carrier support, a plurality of beam guiding and beam forming optical elements mounted to the carrier support in a defined spatial arrangement, and a housing covering the optical elements mounted to the carrier support. The housing comprises a housing panel. The housing panel has two parallel facesheets and a core layer. The core layer is bonded to the two facesheets and includes at least one of a plurality of gas filled cavities and a heavy layer such that the housing panel prevents airborne sound and air flows that occur in the environment of the microscope from exciting the optical elements to vibrations.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components of the drawings are not necessarily to scale, emphasize instead being placed upon clearly illustrating the principles of the present invention. In the drawings, like reference numerals designate corresponding parts throughout the several views.

FIG. 1 is a schematic depiction of a high-resolution microscope according to the present disclosure.

FIG. 2 is a perspective view of a practical embodiment of a housing of the microscope of FIG. 1.

FIG. 3 is a perspective explosion view of a housing panel of the housing of FIG. 2.

FIG. 4 is a side view of a housing panel of another embodiment than that one of FIG. 3.

FIG. 5 is a top view on an inner facesheet of even another embodiment of the housing panel.

FIG. 6 is a side view of a housing panel in another embodiment than that one of FIG. 3; and

FIG. 7 is a side view of a housing panel of even another embodiment than that one of FIG. 3.

### DETAILED DESCRIPTION

In a high-resolution microscope according to the present disclosure comprises a carrier support, a plurality beam guiding and beam forming optical elements mounted to the carrier support in a defined spatial arrangement, and a housing covering the optical elements mounted to the carrier support. The housing includes a housing panel comprising two parallel facesheets and a core layer. The core layer is bonded to the two facesheets by, for example, a material bond or a substance-to-substance bond, and comprises at least one of a plurality of gas filled cavities and a heavy layer, in order to avoid that airborne sound or air flows which occurs in the surroundings of the microscope excite the optical elements to vibrations. In other words, the housing with this particular housing panel is used to prevent the airborne sound and the air flows form exciting the optical elements to vibrations.

In the microscope, the housing, optionally together with the carrier support, may, completely or only incompletely, enclose the optical elements mounted to the carrier support except of necessary beam entrances and beam exits. The functions of the housing explained in the following are often already achieved with incompletely enclosed optical elements. In order to ensure these functions in any case, the housing may always be designed such as to completely or fully enclose the optical elements mounted to the carrier support except of the necessary beam entrances and beam exits, optionally together, i. e. in combination, with the carrier support.

The high-resolution microscope according to the present disclosure is based on the finding that an important source of potential relative movements of a sample on a sample holder with respect to further components of a high-resolution microscope may be attributed to the fact that a housing panel of a housing of the microscope is excited to vibrations, particularly to resonant vibrations. These vibrations may even be excited by airborne sound which is generated by small cooling fans or words soft spoken in the same room in which the microscope is located.

In order to prevent that relative moments between the sample and the microscope are caused by a vibrating housing panel, one could have taken the usual path of designing the supporting structures of the microscope, particularly the carrier support for the beam guiding and beam forming optical elements of the microscope, in a massive and very stiff way. Further, one could have designed the entire housing, which covers the carrier support and the optical elements mounted thereto and which includes the potentially vibrating housing panel, in a massive and very stiff way. However, these measures would not have solved the task of the present disclosure.

The inventors took another path and equipped the housing with a housing panel comprising two parallel facesheets and a core layer bonded to the two facesheets and including at least one of a plurality of gas filled cavities and a heavy layer. Such a panel is generally known for use in other technical field, but not in microscope construction for the purpose of preventing to the excitation of very small relative moments in the nanometer range by airborne sound which, according to a normal standard, would already be considered as very quiet. Particularly, it is about airborne sound below 40 dB or also below 25 dB or even below 20 dB.

By means of designing the housing panel as a sandwich panel with two parallel facesheets and a core layer positive substance or substance-to-substance bonded to the facesheets and including gas filled cavities, the housing panel, without a significant increase of its mass, i. e. weight, is stiffened such that it is not excited by airborne sound to vibrations which could result in relative movements between a sample to be examined and the microscope. Further, neither airborne sound nor air flows which may occur in the surroundings of the microscope may reach the optical elements mounted to the carrier support and covered by the housing. In this way it is prevented that the airborne sound or the air flows excite the optical elements to vibrations.

If the core layers, provided as an alternative or an addition to the plurality of gas filled cavities has a heavy layer, it has a higher mass. However, the prevention of airborne sound or air flows which may occur in the surroundings of the microscope from exciting the optical elements to vibrations, which is achieved by the housing panel, may be further enhanced by means of the heavy layer as compared to by means of a plurality of gas filled cavities only. In practice, a sound transmission loss of above 20 dB can be achieved with housing panels of a thickness of a few millimeters with a plurality of gas filled cavities, whereas a sound transmission of more than 25 dB can be achieved by means of a heavy layer.

Further, due to its multilayered construction including at least one of a plurality of gas filled cavities and the heavy layer, the housing of the high-resolution microscope of the present invention protects the optical element mounted to the carrier support against thermal influences from the outside of the housing.

In opposite direction, i.e. from the interior to the outside, the housing, due to the multilayered construction of its housing panel, protects the surrounding against high-level radiation, particularly laser radiation, which may be scattered, or in an extreme case, even with its full energy be deviated by the optical elements out of the intended beam path. In order to provide this protection, it is preferred that the entire housing and, thus, also the housing panel, particularly its inner facesheet facing the optical element, is laserproof, and that the entire housing and, thus, also the housing panel is flame resistant or at least flame retardant. The laser resistance relates to the maximum intensity at which and the maximum period of time over which high-level radiation potentially acts upon the inner facesheet in the respective microscope. In order to ensure this laser resistance, the inner facesheet may purposefully be thicker than the facesheet facing away from the optical element. As an alternative or an addition to a general laser resistance, the housing panel may be provided with as sensor for monitoring its integrity. For example, the sensor may determine an electric conductivity in the plane of main extension of the housing panel which significantly drops in case of a damage to its inner facesheet.

Often, the present disclosure may already be successfully implemented in that an existing housing panel is identified as being prone to vibrations and replaced by a housing panel constructed according to the present disclosure. However, all housing panels of a housing which are potentially prone to vibrations may, from the outset, be constructed according to the present disclosure.

The carrier support of the microscope to which the beam guiding and beam forming optical elements are mounted may be arranged in a spatially fixed way with respect to a microscope body or microscope stand which includes a sample holder for the respective sample. Due to the housing panel constructed according to the present disclosure, there is no danger that the microscope body is excited to vibrations which, due to the spatially fixed arrangement of the carrier support with respect to the microscope body, could result into relative movements between the sample holder and the beam path of the microscope. This applies independently on whether the carrier support is directly mounted to the microscope body or the carrier support is made as an optical bench and the microscope body is mounted on this optical bench.

However, as a rule, no optical elements of the microscope are mounted to the housing.

The core layer of the housing panel according to the present disclosure may have a thickness in a range from 2 to 22 mm. Preferably, the thickness is in a range from 4 to 10 mm, i.e. about 7 mm. The plurality of the gas filled cavities may make up 50 to 99% of a volume of the core layer. Preferably, they make up between 80% and 98% of the volume of the core layer, i.e. the gas filled cavities make up a by far predominant part of the volume of the core layer. The heavy layer may make up between 10% and 100%, preferably between 50% and 100% of a volume of the core layer.

At least one, preferably both of the two facesheets are closed, i.e. have no openings, except of mounting holes for the passage of mounting screws or the like, which extend through entire housing panel.

However, with regard to the damping or absorption of airborne sound which occurs within the housing, it may be advantageous, if an inner one of the two facesheets has a plurality of sound entrance holes such that the housing panel serves as a sound absorber. In practice, the sound entrance holes may have diameters in a range from 0.1 to 5 mm, preferably from 0.2 to 3 mm, and they may make up between 1 to 20% of a surface area of an inner one of the two facesheets.

A typical thickness of the facesheets is in a range from 0.2 to 2 mm. Preferably, the thickness is in a range between 0.5 and 1.0 mm. These specifications with respect to the thickness of the facesheets particularly apply if at least one, preferably both of the facesheets have a base structure made of a metallic material, i.e. a metal sheet. This metal sheet may be coated, particularly at the outside of the housing panel. Preferably, the metallic material is a light metal, particularly aluminum or an aluminum alloy. In this case, the facesheet may be anodized, particularly at the outside of the housing panel.

The facesheet at the inside of the housing panel may be equipped to be light absorbing, particularly with respect to light in a wavelength range which is used within the microscope, i.e. for example, for light of a fluorescence wavelength but also for light of an excitation and/or a STED wavelength. In practice, this facesheet and all inwardly facing areas of the housing panel, i.e. even parts of the core layer and its opposing facesheet which are accessible through sound entrance openings, may be matt black.

Generally, the facesheets may, in any way, be materially bonded or substance-to-substance bonded to the core layer, i.e. even completely rigidly by point welding or the like. However, in a preferred embodiment, the facesheets are bonded to the core layer via a permanently elastic or permanently viscous adhesive such that a viscoelastic damping of any vibrations of the housing panel is achieved. Alternatively or additionally, such a viscoelastic damping may also be achieved by means of a continuous intermediate layer of the core layer made of a permanently elastic or permanently viscous material. Permanently elastic or permanently viscous adhesives or construction materials with a hardness of not more than 90 Shore A are suitable. A hardness of not more than 75 Shore A is more preferred, and a hardness of not more than 60 Shore A is most preferred.

The core layer of the housing panel constructed according to the present disclosure may be made of a metal sheet meandering between the facesheets, for example of a metal sheet running like a wave between the facesheets. Alternatively or additionally, the core layer may have an open pore or closed pore foam whose pores provides the gas filled cavities. Particularly, the core may be a core of foamed plastic or foamed mineral material. Alternatively or additionally, the core layer may have a honeycomb core with honeycombs running along or crosswise to the facesheets. The honeycomb core may be made of metal or plastic, and, in principle, also of paper or a wood material. Other possible embodiments of the core layer are, for example, made of substance-to-substance bonded spheres or hollow spheres. However, as already explained, it is preferred that the housing panel is at least flame retardant. Thus, its core layer preferably consists of flame resistant or at least flame-retardant materials.

The heavy layer may particularly comprise a viscous polymeric matrix with embedded solid particles preferably made of a metallic, ceramic or mineral material. A shore-hardness of the viscous polymeric matric may be in the range indicated above for the elastic or permanently viscous adhesive or material, i.e. below 90 Shore A, preferably not more than 75 Shore A, and most preferably not more than 60 Shore A. Besides the particles, fibers like, for example, mineral fibers, may also be embedded in the viscous polymeric matrix of the heavy layer. The core layer may also comprise such fibers in the area of gas filled cavities, which are then, bound in an open structure typically by means of an elastic or permanently viscous adhesive or construction material.

In practice, the housing panel constructed according to the present disclosure may close a free opening of a frame of the housing. This frame may be provided as a form-stiff base structure of the housing. In a preferred embodiment, the frame has light weight metal profile sections which are screwed or riveted together. The frame may as a whole consist of such light weight metal profile sections, and the frame may be complemented to the complete housing by a plurality of housing panels constructed according to the present disclosure or by both housing panels constructed according to the present invention and housing panels constructed otherwise.

The free opening of the frame of the housing that is closed by the housing panel constructed according to the present disclosure may be rectangular, and it may have a length between 10 cm and 100 cm. Often, this length of the free opening is between 20 cm and 70 cm. Typically, a width of the free opening is between 5 cm and 60 cm, and often between 10 cm and 45 cm. In the use of the microscope, the free opening, with removed housing panel, allows for an access to the optical elements mounted beneath or behind the free opening in order to check and/or adjust them. Therefore, the housing panel constructed according to the present invention is preferably connected or fixed to the frame in a releasable way. In practice, it may be at least one of inserted or pushed into the frame and screwed to frame for this purpose. Preferably, a position sensor is assigned to the housing panel releasably fixed to the frame, which provides a security signal only if the housing panel actually closes the free opening of the frame. The operation of the microscope and particularly turning on high-power light sources of the microscope may then be dependent on whether the security signal is present. In this way, it is avoided that the microscope is operated without proper coverage of its optical elements by the housing, and that high-level radiation may get out of the housing in the surroundings of the microscope.

As already indicated, besides the housing panel constructed according to the present disclosure, further housing panels constructed according to the present invention, preferably at least four further housing panels constructed according to the present disclosure may be fixed to the frame. Further, housing panels made in another way may, in principle, also connected to the frame.

The housing may itself be supported at the carrier support. Actually, the frame of the housing may be mounted to the carrier support.

The optical elements of the high-resolution microscope mounted to the carrier support and covered by the housing may particularly include the following, wherein this list is by no means complete: beam splitters, beam scanners, lenses, lens groups, phase plates, wavelength selective filters, spatial light modulators (SLM), acousto-optical modulators (AOM), full mirrors, dichroitic mirrors, deformable mirrors, CMOS and CCD cameras. Light detectors may also be mounted to the carrier support and protected there by the housing. However, in a same way as lasers for providing light, these light detectors may also be arranged in a spatially separated way and connected tot the optical element mounted to the carrier support via flexible optical fibers. This particularly applies if the light detectors and lasers are to be actively cooled and if at least a potential excitation of vibrations is associated with this cooling.

As already stated, the high-resolution microscope may particularly be a laser scanning microscope, a confocal microscope, a STED microscope or any other RESLOFT microscope, a MINFLUX microscope or a localization microscope like, for example, a GSDIM microscope. The larger the spatial resolution to be achieved by the respective high-resolution microscope, the more important it is to prevent relative movements between the respective sample and the microscope.

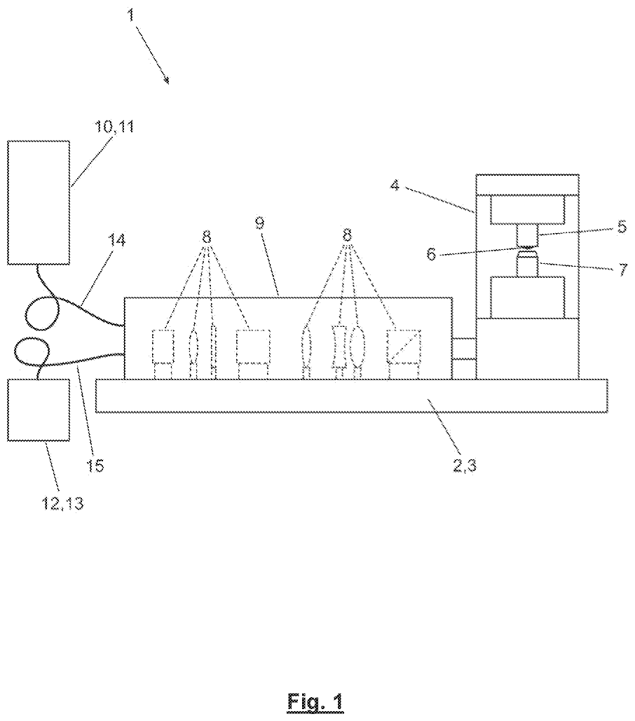

Referring now in greater detail to the drawings, the high-resolution microscope 1 depicted in FIG. 1 comprises a carrier support 2 which is indicated as being an optical bench 3, here. A microscope body 4 is mounted to the carrier support 2. The microscope body 4 includes a sample holder 5 for a sample 6 by which the sample 6 is positioned with respect to an objective lens 7 and, thus, with respect to a beam path of the microscope 1. Various beam guiding and beam shaping optical elements 8 are arranged in the beam path of the objective lens 7, which, like the microscope body 4 are mounted to the carrier support 2 and which are covered by a housing 9. On the other hand, a light source 10 in form of one more lasers 11 and, here, also a detection device 12 in form of one or more light sensors 13 are not mounted to the carrier support 2. The light source 10 and the detection device 12 are connected to the optical set up of the microscope 1 on the carrier support 2 via flexible optical fibers 14, 15. The housing 9 protects the optical elements 8 on the carrier support against damage and contamination. It prevents the entrance of light out of the surroundings into the optical set up. It prevents thermal influences from the outside on the optical set up; and it prevents the incidence of airborne sound out of the surroundings on the optical elements 8. In order to not be excited to vibrations by the airborne sound itself, which vibrations would have an effect in form of relative movements of the sample 6 with respect to the beam path of the microscope 1, the housing 9 is designed and constructed in a special way.

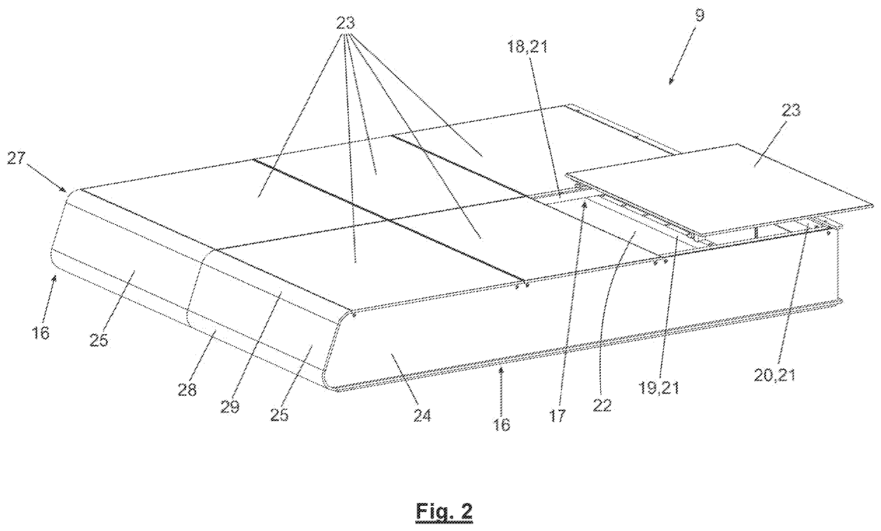

In a separate depiction, FIG. 2 shows a practical embodiment of the housing 9. The housing 9 may be open at its bottom side and, with its bottom side 16, mounted onto the carrier support 2, i. e. the optical bench 3, according to FIG. 1. The housing 9 has a frame 17. The frame 17 consists of bars 18 to 20 which are screwed together. All these bars 18 to 20 are light weight metal profile sections 21. More particularly, the light weight metal profile sections 21 are extruded profile sections. The frame 17 delimits free openings 22 which are each closed by a housing panel 23 to 25. The housing panels 23 to 25 are inserted into the frame 17 and screwed thereto. The visible surfaces of the housing 9, except of edges 26, 27 at the narrow side of the housing which are formed by milled edge profiles 28, 29 are formed by the housing panels 23 to 25.

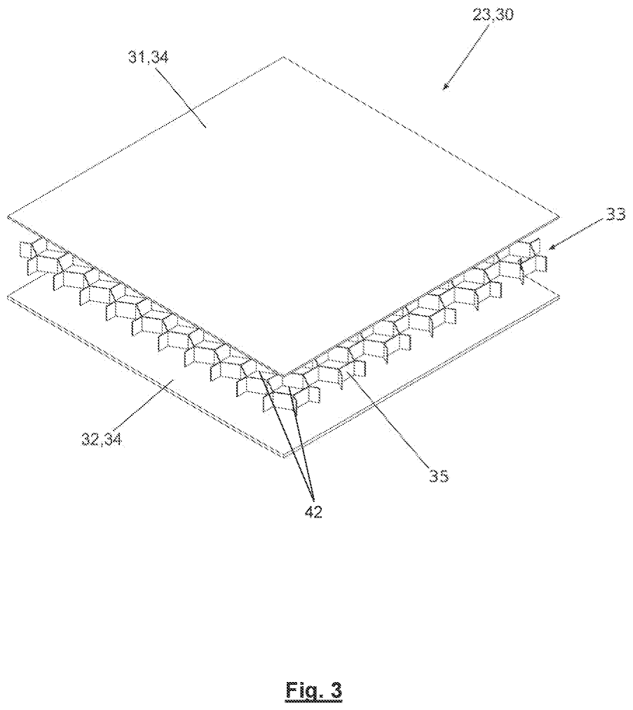

As shown in the explosion view according to FIG. 3 of one of the housing panels 23, the housing panels 23 to 25 are constructed as sandwich panels 30 with two facesheets 31 and 32 and a core layer 33 arranged in between. In the assembled housing panel 23, the facesheets 31 and 32 are substance-to-substance bonded to the core layer 33, particularly by means of a permanently elastic or permanently viscous adhesive in order to provide for viscoelastic damping of any vibrations of the housing panel 23. However, such vibrations are rather not to be expected due to the three-layered construction and the resulting high form-stiffness at a comparatively small mass of the housing panel 23. Actually, the facesheets 31 are anodized aluminum sheets 34 and the core layer 33 is a honeycomb core 35 also made of aluminum, here. The honeycombs delimited by the honeycomb core 35 are gas filled cavities 42 in the core layer 33.

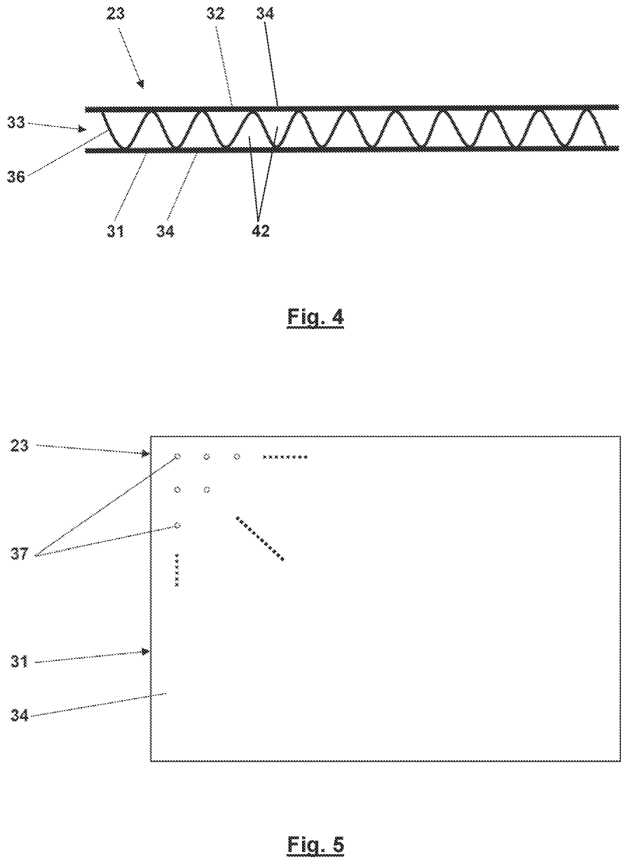

In the embodiment of the housing panel 23 depicted in FIG. 4, the core layer 33 is made of a corrugated sheet 36, i.e. of a sheet meandering between the facesheets 31 and 32 forth and back like a wave. The corrugated sheet 36 is preferably also fixed by means of a permanently elastic or permanently viscous adhesive to the facesheets 31 and 32 in order to provide for viscoelastic damping of any vibrations of the housing panel 23. However, in principle, the corrugated sheet 36 and the facesheets 31 and 32 may also be materially bonded by welding, particularly by electro-welding. The corrugated sheet 36 delimits gas filled cavities 42 in the core layer 33.

FIG. 5 shows that the inner facesheet 31 has sound entrance holes 37 which lead into the gas filled cavities 42 in the core layer 33. In this way, the housing panels 28 is made as a sound absorber for airborne sound which occurs in the interior of the housing 9 and which may, for example, be generated by an optical element to which an actuator is attached that is operated in the operation of the microscope. The sound entrance holes may be distributed over the entire surface of the inner facesheet 31. This is only indicated in FIG. 5.

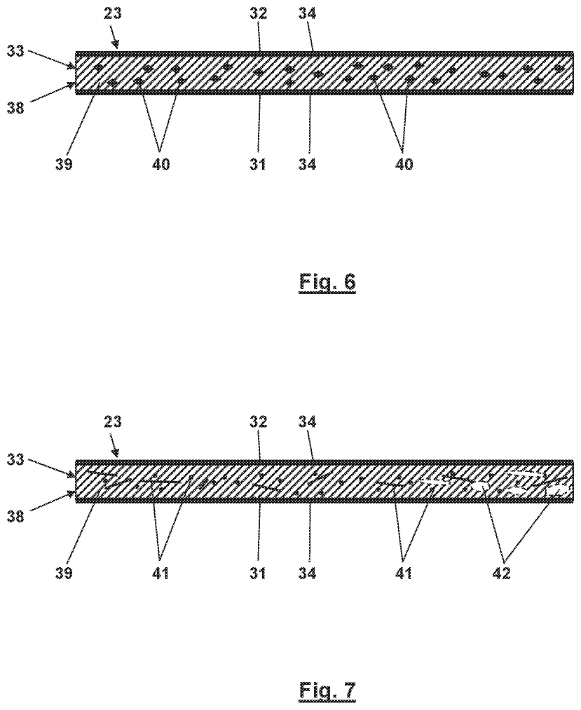

In the embodiment of the housing panel 23 depicted in FIG. 6, the core layer 33 is made of a layer 38 of a viscous polymeric matrix 39 with embedded solid particles 40. The particles 40 may be round or angular, ceramic or mineral particles of a particle size in a range from 0.1 to 2 mm, preferably from 0.5 to 1 mm. The layer 38 serves as a heavy layer and increases the shielding of sound by the housing panel 23. This increase of the sound shielding compensates for the considerable higher average density and also the considerable higher mass per surface area of the housing panel 23 in this embodiment.

In the embodiment of the housing panel 23 depicted in FIG. 7, the core layer 33 is made of a viscous polymeric matrix 39 with embedded fibers 41. The fibers 41 may be mineral fibers of a diameter in a range from 0.1 to 2 mm, preferably from 0.5 to 1 mm. The polymeric matrix may fill up the entire volume of the core layer remaining besides the fibers 41, or it may only serve as a binder for the fibers 41 such that, like indicated in the right-hand side of FIG. 7, gas filled cavities remain in the core layer 33. In any case, the layer 38 may serve as a heavy layer and increases the shielding of sound by the housing panel 23. The increase of the sound shielding compensates for the considerably higher average density and, thus, the considerable higher mass per surface area of the housing panel 23 which is also given in this embodiment, particularly without gas filled cavities 42.

Many variations and modifications may be made to the preferred embodiments of the invention without departing substantially from the spirit and principles of the invention. All such modifications and variations are intended to be included herein within the scope of the present invention, as defined by the following claims.

1. A high-resolution microscope comprising
a carrier support,
a plurality of beam guiding and beam forming optical elements mounted to the carrier support in a defined spatial arrangement, and
a housing covering the optical elements mounted to the carrier support,
wherein the housing comprises a housing panel, the housing panel having two parallel facesheets and a core layer, the core layer bonded to the two facesheets and including at least one of a plurality of gas filled cavities and a heavy layer, and the housing panel preventing airborne sound and air flows that occur in the environment of the microscope from exciting the optical elements to vibrations.

2. The microscope of claim 1,
wherein the carrier support is arranged in a spatially fixed way with respect to a microscope body of the microscope including a sample holder,
wherein the carrier support is mounted to the microscope body, or the carrier support is made as an optical bench and the microscope body is mounted on the optical bench.

3. The microscope of claim 1, wherein no optical elements are mounted to the housing.

4. The microscope of claim 1,
wherein the core layer has a thickness in a range from 2 mm to 20 mm,
wherein the plurality of gas filled cavities make up 50% to 99% of a volume of the core layer, or the heavy layer makes up 10% to 100% of the volume of the core layer.

5. The microscope of claim 1, wherein at least one of the two facesheets has a thickness in a range from 0.2 to 2 mm, and wherein at least one of the two facesheets is closed.

6. The microscope of claim 1, wherein an inner one of the two facesheets that faces towards the optical elements mounted to the carrier support has a plurality of sound entrance holes.

7. The microscope of claim 6, wherein the sound entrance holes have a diameter in a range from 0.5 to 5 mm and make up 1 to 20% of a surface area of the inner one of the two facesheets.

8. The microscope of claim 1, wherein at least one of the two facesheets has a base structure made of a metallic material, wherein at least an inner one of the two facesheets that faces towards the optical elements mounted to the carrier support is laserproof.

9. The microscope of claim 1, wherein the core layer is made of one of flame-retardant and flame-resistant materials.

10. The microscope of claim 1, wherein the facesheets are bonded to the core layer by a permanently elastic or viscous material or that at least one continuous intermediate layer of the core layer is made of a permanently elastic or viscous material, wherein the permanently elastic of viscous material has a hardness of not more than 90 Shore A.

11. The microscope of claim 1, wherein the core layer comprises a metal sheet meandering between the facesheets or a honeycomb structure comprising honeycombs oriented along or crosswise to the facesheets.

12. The microscope of claim 1, wherein the heavy layer comprises a layer made of a viscous polymeric matrix with embedded solid particles made of at least one of a metallic material, a ceramic material and a mineral material.

13. The microscope of claim 1, wherein the housing panel closes an opening of a frame of the housing.

14. The microscope of claim 13, wherein the frame is made of profile sections made of a light weight alloy, the profile sections being screwed or riveted to one another.

15. The microscope of claim 13, wherein the opening is a rectangular opening having a length in a range between 20 cm and 70 cm and a width in a range between 10 cm and 45 cm.

16. The microscope of claim 13, wherein the housing panel is releasably connected to the frame.

17. The microscope of claim 13, wherein at least two further equal housing panels are connected to the frame.

18. The microscope of claim 13, wherein the housing is supported at the carrier support, wherein the frame is mounted to the carrier support.

19. The microscope of claim 1, wherein the plurality of optical elements which are mounted to the carrier support and covered by the housing include optical elements selected from the group consisting of:
beam splitters,
beam scanners,
lenses,
lens groups,
phase plates,
wave length selective filters,
SLMs,
AOMs,
full mirrors,
dichroitic mirrors,
deformable mirrors,
CMOS and CCD cameras.

20. The microscope of claim 1, wherein the high-resolution microscope is one of a laser scanning microscope, a confocal microscope, a STED microscope, a MINFLUX microscope and a localization microscope.
